(19) United States
(12) Patent Application Publication
(10) Pub. No.: US 2008/0254251 A1
(43) Pub. Date: Oct. 16, 2008

(54) OPTICAL INFORMATION RECORDING MEDIUM AND METHOD OF RECORDING AND REPRODUCING INFORMATION

(75) Inventors: Tetsuya WATANABE, Kanagawa (JP); Takeshi Kakuta, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Tokyo (JP)

(21) Appl. No.: 12/100,439

(22) Filed: Apr. 10, 2008

(30) Foreign Application Priority Data
Apr. 13, 2007 (JP) 2007-106391

(51) Int. Cl. B32B 3/02

(52) U.S. Cl. 428/64.4; 430/322

(57) ABSTRACT

The optical information recording medium comprises a recording layer on a surface of a support. The surface of the support has pregrooves with a track pitch ranging from 50 to 500 nm, and the recording layer comprises a phthalocyanine derivative denoted by general formula (I) and a compound denoted by general formula (II).

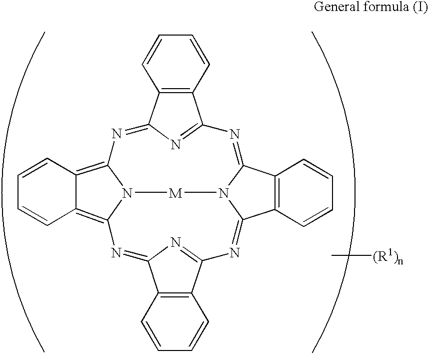

In general formula (I), R¹ denotes a substituent, n denotes an integer ranging from 1 to 16, and M denotes a metal atom optionally comprising a ligand, a metal oxide, or two hydrogen atoms.

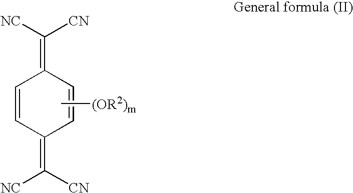

In general formula (II), R² denotes a substituted or unsubstituted alkyl group having 1 to 18 carbon atoms or a substituted or unsubstituted aryl group having 4 to 24 carbon atoms, and m is an integer ranging from 1 to 4.

### CROSS-REFERENCE TO RELATED APPLICATIONS

This application claims the benefit of priority under 35 USC 119 to Japanese Patent Application No. 2007-106391 filed on Apr. 13, 2007, which is expressly incorporated herein by reference in its entirety.

### BACKGROUND OF THE INVENTION

1. Field of the Invention

The present invention relates to an optical information recording medium and a method of recording and reproducing information permitting the recording and reproducing of information with a laser beam, More particularly, the present invention relates to a heat mode-type optical information recording medium suited to the recording of information by irradiation of a short-wavelength laser beam with a wavelength of equal to or shorter than 450 nm.

2. Discussion of the Background

The recordable CD (CD-R) and recordable DVD (DVD-R) have been known as optical information recording media permitting the “write-once” recording of information with a laser beam. In contrast to the recording of information on a CD-R, which is conducted with a laser beam in the infrared range (normally, at a wavelength of about 780 nm), the recording of information on a DVD-R is conducted with a visible light laser beam (with a wavelength of about 630 to 680 nm). Since a recording laser beam of shorter wavelength is employed for a DVD-R than for a CD-R, the DVD-R has an advantage of being able to record at higher density than on a CD-R. Thus, the status of the DVD-R as a high-capacity recording medium has to some degree been ensured in recent years.

Networks, such as the Internet, and high-definition television have recently achieved widespread popularity. With high-definition television (HDTV) broadcasts near at hand, demand is growing for high-capacity recording media for recording image information both economically and conveniently. However, the CD-R and DVD-R do not afford recording capacities that are adequate to handle future needs. Accordingly, to increase the recording density by using a laser beam of even shorter wavelength than that employed in a DVD-R, the development of high-capacity disks capable of recording with laser beams of short wavelength is progressing. For example, an optical recording disk known as the “Blu-ray,” employing a blue laser of 405 nm, and HD-DVD have been proposed. Furthermore, for example, Japanese Unexamined Patent Publication (KOKAI) No. 2001-287460, Japanese Unexamined Patent Publication (KOKAI) No. 2001-287465 or English language family member U.S. Patent Application Publication No. 2003/194646, Japanese Unexamined Patent Publication (KOKAI) No. 2001-253171 or English language family member U.S. Patent Application Publication No. 2003/091931, Japanese Unexamined Patent Publication (KOKAI) Nos. 2001-39034, 2000-318313, 2000-318312, 2000-280621, 2000-280620, 2000-263939, 2000-222772, 2000-222771, 2000-218940, 2000-158818, 2000-149320, 2000-108513, 2000-113504, 2002-301870 or English language family member U.S. Patent Application Publication No. 2003/138728; U.S. Patent Application Publication No. 2002/76648; and Japanese Unexamined Patent Publication (KOKAI) Nos. 2003-94828 and 2007-7954, which are expressly incorporated herein by reference in their entirety, propose recording and reproduction of information by irradiation with a blue (wavelength 400 to 430 nm, or 488 nm) or blue-green laser beam (wavelength 515 nm) on disks employing recording dyes such as porphyrin compounds, azo dyes, metallic azo dyes, quinophthalone dyes, trimethinecyanine dyes, dicyanovinylphenyl-skeleton dyes, coumarin compounds, and naphthalocyanine compounds.

Of these recording dyes, the phthalocyanine dyes in particular (see Japanese Unexamined Patent Publication (KOKAI) No. 2002-301870) afford high stability to light, temperature and humidity, and are thus desirable from a practical standpoint. However, the intensity of absorption in the UV range (referred to as “Soret band absorption”) of phthalocyanine dyes is not necessarily adequate at the oscillation wavelengths of lasers with short wavelengths of equal to or shorter than 450 nm. As for the phthalocyanine dyes, this renders problematic any improvement in recording sensitivity during recording by irradiation with short-wavelength lasers. Japanese Unexamined Patent Publication (KOKAI) No. 2007-7954 proposes that a compound having considerable absorption at a wavelength ranging from 340 to 440 nm be added to the recording layer, in addition to the phthalocyanine dye to solve this problem. However, extensive research by the present inventors determined that further improvement is required from the perspective of light resistance of the recording layer (dye layer) in the optical information recording medium described in Japanese Unexamined Patent Publication (KOKAI) No. 2007-7954.

### SUMMARY OF THE INVENTION

An aspect of the present invention provides for an optical information recording medium having good recording characteristics that permits the high-density recording and reproduction of information by irradiation of a short-wavelength laser beam, more particularly, a short-wavelength laser beam having a wavelength of equal to or shorter than 450 nm, and still more particularly, a semiconductor laser beam having a wavelength in the vicinity of 405 nm that has been used widely.

Another aspect of the present invention provides for an optical information recording medium affording high storage stability by enhancing the light resistance of the recording layer.

An aspect of the present invention relates to an optical information recording medium comprising a recording layer on a surface of a support, wherein the surface of the support has pregrooves with a track pitch ranging from 50 to 500 nm, and the recording layer comprises a phthalocyanine derivative denoted by general formula (I) and a compound denoted by general formula (II).

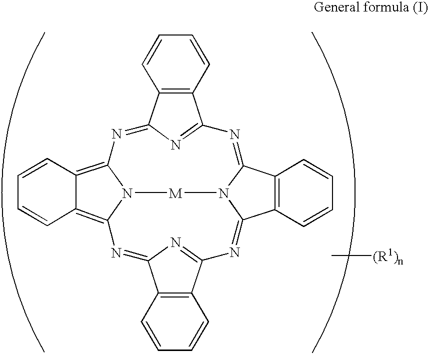

In general formula (I), R¹ denotes a substituent, n denotes an integer ranging from 1 to 16, plural ns may be identical or different from each other when n is an integer of equal to or greater than 2, and M denotes a metal atom optionally comprising a ligand, a metal oxide, or two hydrogen atoms.

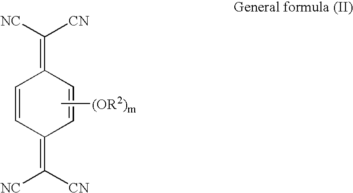

In general formula (II), R² denotes a substituted or unsubstituted alkyl group having 1 to 18 carbon atoms or a substituted or unsubstituted aryl group having 4 to 24 carbon atoms, m is an integer ranging from 1 to 4, and plural R²s may be identical or different from each other when m denotes an integer of equal to or greater than 2.

The optical information recording medium may further comprise a light reflective layer between the support and the recording layer.

The light reflective layer may have a thickness ranging from 5 to 100 nm.

The optical information recording medium may further comprises a barrier layer, a bonding layer or adhesive layer, and a protective layer in this order on a surface of the recording layer, the surface being opposite from the surface facing the support.

On the optical information recording medium, information may be recorded by irradiation of a laser beam having a wavelength of equal to or shorter than 450 nm.

The recording layer may comprise the compound denoted by general formula (II) in an amount of 1 to 20 weight parts per 100 weight parts of the phthalocyanine derivative denoted by general formula (I).

R¹ in general formula (I) may denote a substituent selected from the group consisting of an substituted or unsubstituted alkylsulfonyl group having 1 to 21 carbon atoms, substituted or unsubstituted arylsulfonyl group having 4 to 24 carbon atoms, substituted or unsubstituted alkylsulfinyl group having 1 to 21 carbon atoms, substituted or unsubstituted arylsulfinyl group having 4 to 24 carbon atoms, substituted or unsubstituted alkylsulfamoyl group having 1 to 21 carbon atoms, and substituted or unsubstituted arylsulfamoyl group having 4 to 24 carbon atoms.

M in general formula (I) may denote a copper atom, magnesium atom, zinc atom, or silicon atom.

A further aspect of the present invention relates to a method of recording and reproducing information by irradiation of a laser beam having a wavelength of equal to or shorter than 450 nm onto the above optical information recording medium.

The present invention can provide an optical information recording medium having excellent storage stability and excellent recording characteristics in the short wavelength region.

Other exemplary embodiments and advantages of the present invention may be ascertained by reviewing the present disclosure and the accompanying drawings.

### BRIEF DESCRIPTION OF THE DRAWINGS

The present invention will be described in the following text by the exemplary, non-limiting embodiments shown in the figures, wherein:

FIG. 1 is a schematic sectional view of an example of the optical information recording medium of the present invention.

Explanations of symbols in the drawings are as follows:
10A First optical information recording medium
12 First support
14 First recordable recording layer
16 Cover layer
18 First light reflective layer
20 Barrier layer
22 First bonding layer or first adhesive layer
44 Hard coat layer

### DESCRIPTIONS OF THE EMBODIMENTS

The following preferred specific embodiments are, therefore, to be construed as merely illustrative, and non-limiting to the remainder of the disclosure in any way whatsoever. In this regard, no attempt is made to show structural details of the present invention in more detail than is necessary for fundamental understanding of the present invention; the description taken with the drawings making apparent to those skilled in the art how several forms of the present invention may be embodied in practice.

### Optical Information Recording Medium

The optical information recording medium of the present invention comprises a recording layer on a surface of a support. The surface of the support on which the recording layer is provided has pregrooves with a track pitch ranging from 50 to 500 nm. The optical information recording medium of the present invention is suitable as a high-density recording optical disk for recording information with short-wavelength lasers, such as a BD or HD-DVD.

The above-described hisgh-density recording optical disk is structurally characterized by a narrower track pitch than conventional recordable optical disks. Further, optical disks of the BD configuration have a layer structure, differing from that of conventional recordable optical disks, in the form of a reflective layer and a recording layer sequentially provided on a support, and a relatively thin protective layer (commonly referred to as a “cover layer”) present on the recording layer. In such optical information recording media for recording with short-wavelength laser, there has been a problem in that adequate recording and reproduction characteristics cannot not be achieved with the dyes employed as recording dyes in conventional recordable optical information recording media such as CD-Rs and DVD-Rs due to differences in this layer structure.

By contrast, in the present invention, the phthalocyanine derivative denoted by general formula (I) below is incorporated into the recording layer in addition to the compound denoted by general formula (II) below in an optical information recording medium of narrower track pitch than conventional recordable optical information recording media, thereby affording good recording and reproduction characteristics. The optical information recording medium of the present invention can afford good recording and reproduction characteristics by irradiation of a laser beam of short wavelength (such as a wavelength of equal to or shorter than 450 nm). In particular, the optical information recording medium of the present invention is suitable as a BD-configured medium having a structure comprising a reflective layer between the support and recording layer.

The present inventors also discovered that optical information recording media of BD configuration also present the following problems.

BD-configured optical information recording media generally comprise a support on which are sequentially provided a light reflective layer, a recording layer, and a cover layer. The optical reflective layer can contribute reflected light during recording to enhance recording sensitivity.

Generally, the thickness and reflectance of the reflective layer are proportional up to a certain thickness of the reflective layer. For example, in the case of a silver reflective layer, the reflectance increases up to about 100 nm in thickness. Thus, to effectively utilize the reflected light, a reflective layer of equal to or greater than 100 nm in thickness is desirable. However, a thick reflective layer results in pregrooves on the reflective layer that are narrower than those on the support, making it difficult to achieve adequate characteristics (depth of modulation). As a countermeasure, when thinking of the grooves on the support as being narrow, it is conceivable to widen and deepen the grooves on the support itself. However, in high-density recording optical disks such as Blu-ray disks, the track pitch is narrower (desirably less than or equal to 330 nm) than the track pitch (720 nm) of DVD-Rs. Thus, it is undesirable to widen the grooves on the support from the perspective of molding. Accordingly, to obtain the necessary groove width when the track pitch has been narrowed to increase recording density, it is desirable to employ as thin a reflective layer as possible within the range where reflectance is achieved. However, when a thin reflective layer is employed, reflectance decreases relative to what it is in a reflective layer of adequate thickness, and recording sensitivity drops. Accordingly, to compensate for the reduction in sensitivity due to the reduction in thickness of the reflective layer, it becomes necessary to increase the sensitivity of the recording layer itself.

Further, Blu-ray optical disks are generally stored with the label side (the opposite side from the recording layer) facing up. When stored with the label side facing up, indoor light, natural light, and the like are blocked by the reflective layer before reaching the recording layer, making it possible to prevent deterioration of the dye in the recording layer. However, when the reflective layer is thinned to enhance recording density as set forth above, the light-passing property of the reflective layer increases, and light resistance during storage deteriorates. This deterioration is particularly pronounced when the sensitivity of the recording layer itself is enhanced.

By contrast, the present invention can provide a BD-configured optical information recording medium with a narrow track pitch and thin reflective layer in which the combination of the phthalocyanine derivative denoted by general formula (I) and the compound denoted by general formula (II) achieves both good sensitivity and light resistance.

The optical information recording medium of the present invention will be described in greater detail below.

### Phthalocyanine Derivative Denoted by General Formula (I)

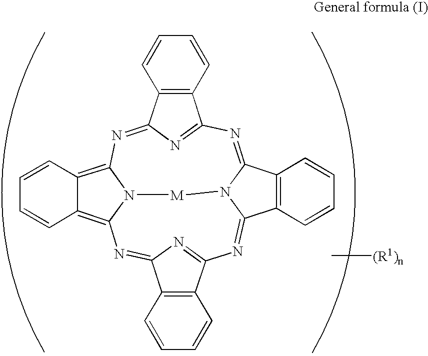

In general formula (I), R¹ denotes a substituent. Examples of the substituent denoted by R¹ are: a halogen atom, a cyano group, a nitro group, a formyl group, a carboxyl group, a sulfo group, a substituted or unsubstituted alkyl group having 1 to 20 carbon atoms, a substituted or unsubstituted aryl group having 6 to 14 carbon atoms, a substituted or unsubstituted heterocyclic group having 1 to 10 carbon atoms, a substituted or unsubstituted alkoxy group having 1 to 20 carbon atoms, a substituted or unsubstituted aryloxy group having 6 to 14 carbon atoms, a substituted or unsubstituted acyl group having 2 to 21 carbon atoms, a substituted or unsubstituted alkylsulfonyl group having 1 to 21 carbon atoms, a substituted or unsubstituted arylsulfonyl group having 4 to 24 carbon atoms, a heterylsulfonyl group having 1 to 10 carbon atoms, an alkylsulfinyl group having 1 to 21 carbon atoms, an arylsulfinyl group having 4 to 24 carbon atoms, a substituted or unsubstituted carbamoyl group having 1 to 25 carbon atoms, an alkylsulfamoyl group having 1 to 21 carbon atoms, an arylsulfamoyl group having 4 to 24 carbon atoms, a substituted or unsubstituted alkoxycarbonyl group having 2 to 20 carbon atoms, a substituted or unsubstituted aryloxycarbonyl group having 7 to 15 carbon atoms, a substituted or unsubstituted acylamino group having 2 to 21 carbon atoms, a substituted or unsubstituted sulfonylamino group having 1 to 20 carbon atoms, or a substituted or unsubstituted amino group having 0 to 36 carbon atoms.

R¹ preferably denotes a halogen atom, carboxyl group, sulfo group, substituted or unsubstituted alkyl group having 1 to 16 carbon atoms, substituted or unsubstituted alkoxy group having 1 to 16 carbon atoms, substituted or unsubstituted alkoxycarbonyl group having 1 to 13 carbon atoms, substituted or unsubstituted acylamino group having 2 to 21 carbon atoms, substituted or unsubstituted sulfonylamino group having 1 to 18 carbon atoms, substituted or unsubstituted alkylsulfonyl group having 1 to 21 carbon atoms, substituted or unsubstituted arylsulfonyl group having 4 to 24 carbon atoms, substituted or unsubstituted alkylsulfinyl group having 1 to 21 carbon atoms, substituted or unsubstituted arylsulfinyl group having 4 to 24 carbon atoms, substituted or unsubstituted alkylsulfamoyl group having 1 to 21 carbon atoms, or substituted or unsubstituted arylsulfamoyl group having 4 to 24 carbon atoms; more preferably denotes an alkylsulfonyl group having 1 to 21 carbon atoms, substituted or unsubstituted arylsulfonyl group having 4 to 24 carbon atoms, substituted or unsubstituted alkylsulfinyl group having 1 to 21 carbon atoms, substituted or unsubstituted arylsulfinyl group having 4 to 24 carbon atoms, substituted or unsubstituted alkylsulfamoyl group having 1 to 21 carbon atoms, or substituted or unsubstituted arylsulfamoyl group having 4 to 24 carbon atoms; and further preferably, denotes a substituted or unsubstituted alkylsulfonyl group having 1 to 21 carbon atoms.

The R¹ substitution position is preferably the alpha-position on the phthalocyanine ring from the perspective of obtaining the particularly excellent optical characteristics when incorporated into a recording layer.

In general formula (I), further substituents may be present on substituent R¹. Examples of these substituents are given below:

A chainlike or cyclic alkyl group having 1 to 20 carbon atoms (such as a methyl group, ethyl group, isopropyl group, or cyclohexyl group); an aryl group having 6 to 18 carbon atoms (such as a phenyl group, chlorophenyl group, 2,4-di-t-amylphenyl group, or 1-naphthyl group), an aralkyl group having 7 to 18 carbon atoms (such as a benzyl group or anisyl group), an alkenyl group having 2 to 20 carbon atoms (such as a vinyl group or 2-methylvinyl group), an alkynyl group having 2 to 20 carbon atoms (such as an ethynyl group, 2-methylethynyl group, or 2-phenylethynyl group), a halogen atom (such as F, Cl, Br, or I), a cyano group, a hydroxyl group, a carboxyl group, an acyl group having 2 to 20 carbon atoms (such as an acetyl group, benzoyl group, salicyloyl group, or pivaloyl group), an alkoxy group having 1 to 20 carbon atoms (such as a methoxy group, butoxy group, or cyclohexyloxy group), an aryloxy group having 6 to 20 carbon atoms (such as a phenoxy group, 1-naphthoxy group, or toluoyl group), an alkylthio group having 1 to 20 carbon atoms (such as a methylthio group, butylthio group, benzylthio group, or 3-methoxypropylthio group), an arylthio group having 6 to 20 carbon atoms (such as a phenylthio group or 4-chlorophenylthio group), an alkylsulfonyl group having 1 to 20 carbon atoms (such as a methanesulfonyl group or butanesulfonyl group), an arylsulfonyl group having 6 to 20 carbon atoms (such as a benzenesulfonyl group or para-toluenesulfonyl group), a carbamoyl group having 1 to 17 carbon atoms (such as an unsubstituted carbamoyl group, methylcarbamoyl group, ethylcarbamoyl group, n-butylcarbamoyl group, or dimethylcarbamoyl group), an amido group having 1 to 16 carbon atoms (such as an acetamide group or benzamide group), an acyloxy group having 2 to 10 carbon atoms (such as an acetoxy group or benzoyloxy group), an alkoxycarbonyl group having 2 to 10 carbon atoms (such as a methoxycarbonyl group or ethoxycarbonyl group), or a five or six-membered heterocyclic group (such as an aromatic heterocycle such as a pyridyl group, thienyl group, furyl group, thiazolyl group, imidazolyl group, or pyrazolyl group, or a heterocycle such as a pyrrolidine ring, piperidine ring, morpholine ring, pyran ring, thiopyran ring, dioxane ring, or dithiolane ring).

Examples of preferable substituents on substituent R¹ in general formula (I) are chainlike and cyclic alkyl groups having 1 to 16 carbon atoms, aryl groups having 6 to 14 carbon atoms, aralkyl groups having 7 to 15 carbon atoms, alkoxy groups having 1 to 16 carbon atoms, aryloxy groups having 6 to 14 carbon atoms, halogen atoms, alkoxycarbonyl groups having 2 to 17 carbon atoms, carbamoyl groups having 1 to 10 carbon atoms, and amide groups having 1 to 10 carbon atoms. Of these, chainlike and cyclic alkyl groups having 1 to 10 carbon atoms, aralkyl group having 7 to 13 carbon atoms, aryl groups having 6 to 10 carbon atoms, alkoxy groups having 1 to 10 carbon atoms, aryloxy groups having 6 to 10 carbon atoms, chlorine atoms, alkoxycarbonyl groups having 2 to 11 carbon atoms, carbamoyl groups having 1 to 7 carbon atoms, and amide groups having 1 to 8 carbon atoms are preferred, and chainlike, branched, and cyclic alkyl groups having 3 to 10 carbon atoms and alkoxycarbonyl groups having 3 to 9 carbon atoms are of still greater preference.

In general formula (I), n denotes an integer ranging from 1 to 16. When n is an integer of equal to or greater than 2, plural R¹s may be identical or different from each other; n is preferably an integer ranging from 1 to 8, more preferably an integer ranging from 4 to 8, and still more preferably, 4.

In the phthalocyanine derivative of particularly preference denoted by general formula (I), R¹ denotes an alkylsulfonyl group having 1 to 21 carbon atoms, the R¹ substitution site is the alpha position on the phthalocyanine ring, and n is 4.

In general formula (I), M denotes a metal atom optionally comprising a ligand, a metal oxide, or two hydrogen atoms. From the perspective of exhibiting a suitable absorption waveform as an optical information recording dye for a laser beam of equal to or shorter than 450 nm, M preferably denotes a copper atom, nickel atom, iron atom, cobalt atom, palladium atom, magnesium atom, aluminum atom, vanadium atom, gallium atom, zinc atom, or silicon atom; more preferably denotes a copper atom, magnesium atom, zinc atom, or silicon atom; and still more preferably, denotes a copper atom. An example of the metal oxide is vanadium oxide.

(I-1) to (I-15) are given along with general formula (I′) and Table 1 below, which specifies them, as preferable specific examples of the phthalocyanine derivative denoted by general formula (I). (I-16) to (I-18) are also preferable specific examples of the phthalocyanine derivative denoted by general formula (I). However, the present invention is not limited thereto. These may be mixtures of substitution position isomers or single isomers.

TABLE 1

| | |
|---|---|
| | General formula (I′) |
| 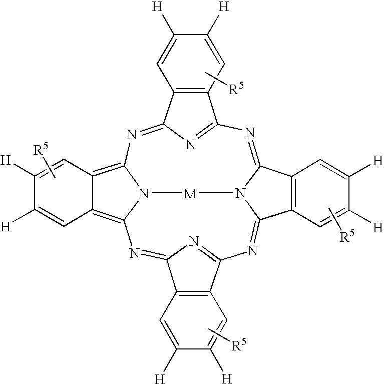 | |

| No. | R⁵ | M |
|---|---|---|
| (I-1) | SO₂CH(CH₃)CH₂CH₃ | Cu |
| (I-2) | SO₂C(CH₃)₃ | Cu |
| (I-3) | SO₂CH(CH₃)₂ | Cu |
| (I-4) | SO₂CH(CH₃)CH₂CH₃ | Mg |
| (I-5) | SO₂CH(CH₃)CH₂CH₃ | Pd |
| (I-6) | SO₂CH(CH₃)CH₂CH₃ | V═O |
| (I-7) | SO₂CH(CH₃)CH₂CH₃ | Zn |
| (I-8) | SO₂CH(CH₃)CH₂CH₃ | Si(OCH₂CH₃)₂ |
| (I-9) | SOCH(CH₃)CH₂CH₃ | Cu |
| (I-10) | SOCH(CH₃)CH₂CH₃ | Pd |
| (I-11) | SO₂NHCH(CH₃)CH₂CH₃ | Cu |
| (I-12) | CO₂CH₂CH₂CH₃ | Cu |
| (I-13) | CH(CH₃)₂ | Cu |
| (I-14) | SCH(CH₃)₂ | Cu |
| (I-15) | OCH(CH₃)₂ | Cu |

(I-16)

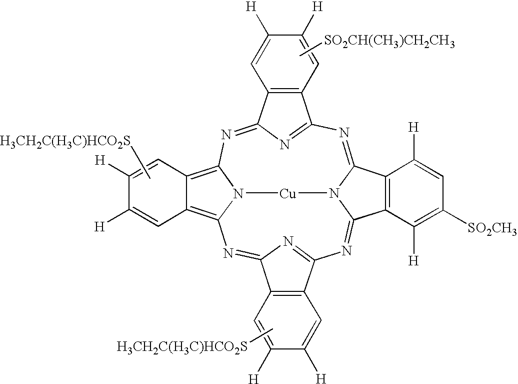

(I-17)

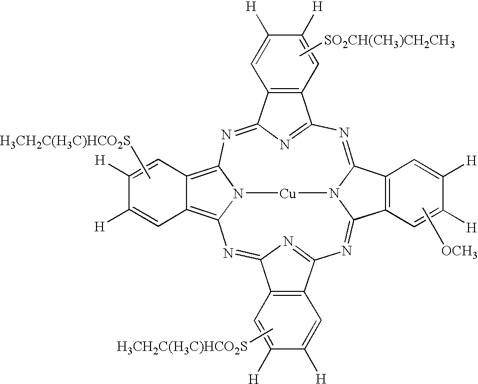

(I-18)

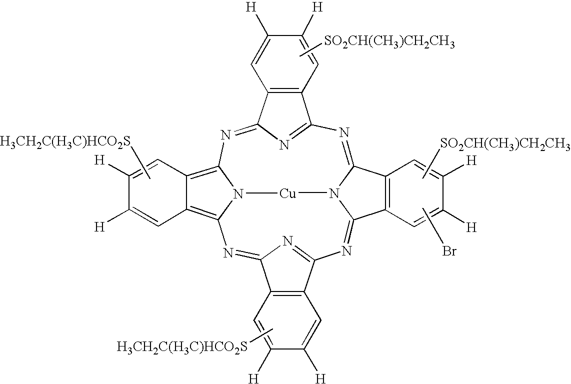

Phthalocyanine derivatives can generally be synthesized by the methods described and/or cited by Shirai and Kobayashi, published by IPC, Inc., “Phthalocyanines—Chemistry and Functions” (pp. 1-62); C. C. Leznoff and A. B. P. Lever, pub. by VCH, “Phthalocyanines—Properties and Applications” (pp. 1-54), which are expressly incorporated herein by reference in their entirety; or similar methods, for example.

### Compound Denoted by General Formula (II)

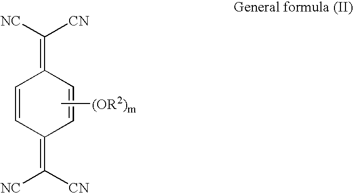

The compound denoted by general formula (II) can perform the function of supplementing the absorption strength of the phthalocyanine derivative denoted by general formula (I) at the oscillation wavelength of the laser in the recording layer and the function of enhancing the light resistance of the recording layer. Thus, excellent recording characteristics and stability for light can be achieved. Enhancement of recording characteristics is attributed to enhanced recording sensitivity by increased efficiency with which the laser beam is absorbed. Increase of stability for light is attributed to the compound functioning as a quencher on the excited state of phthalocyanine.

General formula (II) will be described in detail below.

In general formula (II), R² denotes a substituted or unsubstituted alkyl group having 1 to 18 carbon atoms or a substituted or unsubstituted aryl group having 4 to 24 carbon atoms.

When R² is a substituted alkyl group or substituted aryl group, examples of the substituent are: a hydroxy group, halogen atom, carboxyl group, sulfo group, substituted or unsubstituted alkoxy group having 1 to 16 carbon atoms, alkoxycarbonyl group having 1 to 13 carbon atoms, substituted or unsubstituted acylamino group having 2 to 21 carbon atoms, sulfonylamino group having 1 to 18 carbon atoms, alkylsulfonyl group having 1 to 21 carbon atoms, arylsulfonyl group having 4 to 24 carbon atoms, alkylsulfinyl group having 1 to 21 carbon atoms, arylsulfinyl group having 4 to 24 carbon atoms, alkylsulfamoyl group having 1 to 21 carbon atoms, and arylsulfamoyl group having 4 to 24 carbon atoms. A hydroxy group or halogen atom is preferable as the substituent when a substituent is present on R².

R² is preferably a substituted or unsubstituted alkyl group having 1 to 18 carbon atoms, more preferably a substituted or unsubstituted alkyl group having 1 to 6 carbon atoms.

m is an integer ranging from 1 to 4. Plural R²s may be identical or different from each other when m denotes an integer of equal to or greater than 2. m is preferably 2.

The compound denoted by general formula (II) is preferably the compound denoted by general formula (III) below.

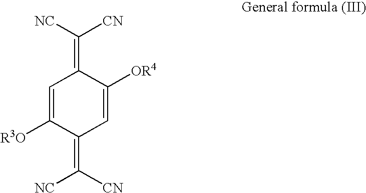

In general formula (III), R³ and R⁴ each independently denote a substituted or unsubstituted alkyl group having 1 to 18 carbon atoms or a substituted or unsubstituted aryl group having 4 to 24 carbon atoms. The details of examples of substituents R³ and R⁴ and their preferable embodiments and the like are identical to those given for R² in general formula (II). When a substituent is present on either R³ or R⁴, both R³ and R⁴ are preferably a 2-hydroxyethyl group.

R³ and R⁴ preferably denote substituted or unsubstituted alkyl groups having 1 to 18 carbon atoms, more preferably unsubstituted alkyl groups having 1 to 6 carbon atoms, and further preferably, methyl groups or ethyl groups.

The content of the compound denoted by general formula (II) in the recording layer is preferably 1 to 50 weight parts, more preferably 1 to 20 weight parts, and further preferably, 1 to 10 weight parts, per 100 weight parts of the phthalocyanine derivative denoted by general formula (I).

(II-1) to (II-8) are given along with general formula (II′) and Table 2 below, which specifies them, as preferable specific examples of the compound denoted by general formula (II). (II-9) and (II-10) are also preferable specific examples of general formula (II). However, the present invention is not limited thereto.

TABLE 2

| | |
|---|---|
| | General formula (II″) |
| 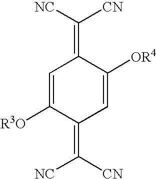 | |

| Compound | R³ | R⁴ |
|---|---|---|
| (II-1) | Me | Me |
| (II-2) | Me | Et |
| (II-3) | Me | Bu |
| (II-4) | Me | CH₂Ph |
| (II-5) | Bu | Bu |
| (II-6) | CH₂CH₂OH | CH₂CH₂OH |
| (II-7) | CH₂CH₂Cl | CH₂CH₂Cl |
| (II-8) | Ph | Ph |

Me = —CH₃
Et = —CH₂CH₃
Bu = —CH₂CH₂CH₂CH₃

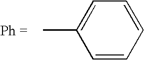

(II-9)

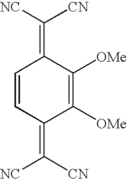

(II-10)

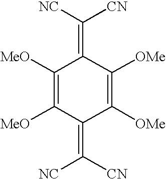

The compound denoted by general formula (II) can be synthesized by known methods, and some of them are also available as a commercial product.

The optical information recording medium of the present invention may comprise one, two, or more of the phthalocyanine derivatives denoted by general formula (I) as recording dyes. The content of the phthalocyanine derivative denoted by general formula (I) in the recording layer can fall within a range of 1 to 100 weight percent, more preferably falls within a range of 70 to 100 weight percent, further preferably falls within a range of 80 to 100 weight percent, and still more preferably, falls within a range of 90 to 100 weight percent of the total weight of the recording layer.

It suffices for the optical information recording medium of the present invention to have at least one recording layer on the support (on a surface having pregrooves with a track pitch of 50 to 500 nm), but it may have two or more such recording layers. One or more recording layers other than recording layers comprising the phthalocyanine derivative denoted by general formula (I) and the compound denoted by general formula (II) may also be present. When the recording layer comorising the phthalocyanine derivative denoted by general formula (I) further comprises other recording dyes, the proportion of the phthalocyanine derivative denoted by general formula (I) to the total dye component is preferably 70 to 100 weight percent, more preferably 80 to 100 weight percent.

When employing dyes other than the phthalocyanine derivative denoted by general formula (I) as dye components in the present invention, these dyes preferably have absorption in the short wavelength region of equal to or shorter than 450 nm, for example. Such dyes are not specifically limited; examples are azo dyes, azo metal complex dyes, phthalocyanine dyes, oxonol dyes, and cyanine dyes.

In the optical information recording medium of the present invention, the recording layer comprising the phthalocyanine derivative denoted by general formula (I) and the compound denoted by general formula (II) is a layer permitting the recording of information by irradiation of a laser beam. The phrase “permitting the recording of information by irradiation of a laser beam” means that the optical characteristics of portions of the recording layer that are irradiated with a laser beam change. The change in optical characteristics is thought to occur when a laser beam is directed onto the recording layer and the irradiated portions absorb the beam, causing the temperature to rise locally and producing a physical or chemical change (such as generating a pit). Reading (reproduction) of information that has been recorded on the recording layer can be achieved by irradiating a laser beam of the same wavelength as that employed in recording, for example, and detecting the difference in optical characteristics, such as the refractive index, between portions where the optical characteristics of the recording layer have been changed (recorded portions) and portions where they have not (unrecorded portions). The phthalocyanine derivative denoted by general formula (I) absorbs laser beams of equal to or shorter than 450 nm, for example. The optical information recording medium of the present invention, which comprises a recording layer comprising the phthalocyanine derivative having absorption in the short wavelength region in this manner together with the compound denoted by general formula (II) is suitable as a large-capacity optical disk permitting recording by a short-wavelength laser, such as an optical disk of the Blu-ray type that employs a blue laser of 405 nm. The method for recording information on the optical information recording medium of the present invention will be described further below.

The optical information recording medium of the present invention comprises at least the above-described recording layer on a support, and may further comprise a light reflective layer, a protective layer, and the like in addition to the above-described recording layer.

Any of the various materials conventionally employed as support materials for optical information recording media may be selected for use as the support employed in the present invention. A transparent disk-shaped support is preferably employed as the support.

Specific examples are glass, acrylic resins such as polycarbonate and polymethyl methacrylate, vinyl chloride resins such as polyvinyl chloride and vinyl chloride copolymers, epoxy resins, amorphous polyolefins, polyesters, and metals such as aluminum. They may be employed in combination as desired.

Of the above materials, thermoplastic resins such as amorphous polyolefins and polycarbonates are preferable, and polycarbonates are particularly preferable, from the perspectives of resistance to humidity, dimensional stability, low cost, and the like. When employing these resins, the support can be manufactured by injection molding.

The thickness of the support generally falls within a range of 0.7 to 2 mm, preferably a range of 0.9 to 1.6 mm, and more preferably, within a range of 1.0 to 1.3 mm.

To enhance smoothness and increase adhesive strength, an undercoating layer can be formed on the surface of the support on the side on which the light reflective layer, described further below, is positioned.

Tracking guide grooves or irregularities (pregrooves) denoting information such as address signals are formed on the surface of the support on which the recording layer is formed. The track pitch of these pregrooves falls within a range of 50 to 500 nm. A support on which a narrower track pitch than that employed in CD-Rs and DVD-Rs is formed to achieve a higher recording density is employed in the optical information recording medium of the present invention. The preferable range of the track pitch will be described in detail further below.

An optical information recording medium (referred to as “Embodiment (1)” hereinafter) sequentially comprising, from the support side, a support 0.7 to 2 mm in thickness, a dye-containing recordable layer, and a cover layer 0.01 to 0.5 mm in thickness is an example of a preferable embodiment of the optical information recording medium of the present invention.

In Embodiment (1), it is preferable for the pregrooves formed on the support to be 50 to 500 nm in the track pitch, 25 to 250 nm in the groove width, and 5 to 150 nm in the groove depth.

Optical information recording medium of Embodiment (1) will be described in detail below.

### Optical Information Recording Medium of Embodiment (1)

The optical information recording medium of Embodiment (1) comprises at least a support, a recordable layer, and a protective layer (cover layer). The optical information recording medium of Embodiment (1) is suitable as a Blu-ray type recording medium. In the Blu-ray system, information is recorded and reproduced by irradiation of a laser beam from the cover layer side, and a light reflective layer is normally provided between the support and the recording layer.

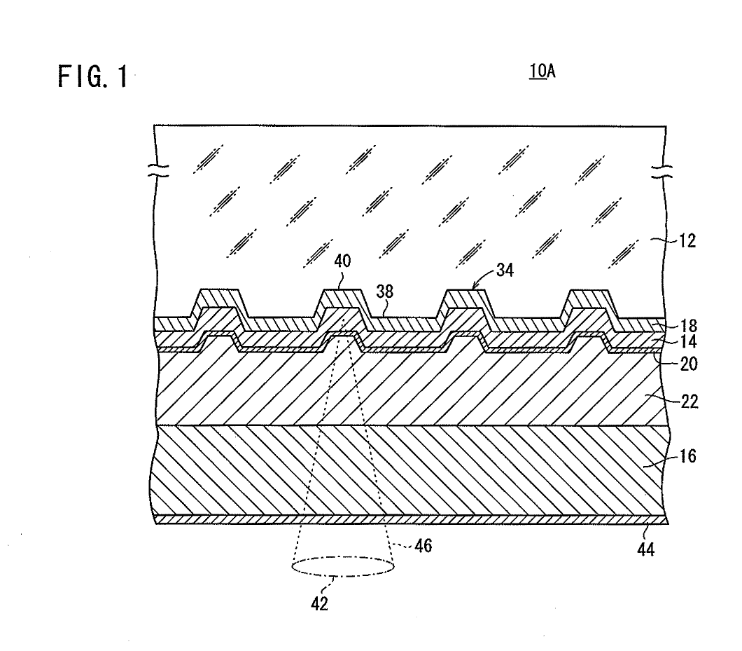

FIG. 1 shows an example of an optical information recording medium of Embodiment (1). The first optical information recording medium 10A shown in FIG. 1 is comprised of first light reflective layer 18, first recordable layer 14, barrier layer 20, first first bonding layer or first adhesive layer 22, and cover layer 16, in that order on first support 12

These materials constituting these components will be sequentially described below

### Support

On the support of Embodiment (1) are formed pregrooves (guide grooves) having a shape such that the track pitch, groove width half width), groove depth, and wobble amplitude all fall within the ranges given below. The pregrooves are provided to achieve a recording density greater than that of CD-Rs and DVD-Rs. For example, the optical information recording medium of the present invention is suited to use as a medium for blue-violet lasers.

The track pitch of the pregrooves ranges from 50 to 500 nm. When the track pitch is equal to or greater than 50 nm, not only is it possible to correctly form the pregrooves, but the generation of crosstalk can be avoided. At equal to or less than 500 nm, high-density recording is possible. The upper limit of the track pitch of the pregrooves is preferably equal to or less than 420 nm, more preferably equal to or less than 370 nm, and still more preferably, equal to or less than 330 nm. The lower limit is preferably equal to or greater than 100 nm, more preferably equal to or greater than 200 nm, and still more preferably, equal to or greater than 260 nm.

The groove width (half width) of the pregrooves ranges from 25 to 250 nm. The upper limit is preferably equal to or lower than 200 nm more preferably equal to or lower than 170 nm, and still more preferably, equal to or lower than 150 nm. The lower limit is preferably equal to or higher than 50 nm, more preferably equal to or higher than 80 nm, and still more preferably, equal to or higher than 100 nm. A pregroove width of equal to or higher than 25 nm can permit adequate transfer of the grooves during molding and can inhibit a rise in the error rate during recording. A groove width of equal to or lower than 250 nm can also permit adequate transfer of grooves during molding and can avoid crosstalk due to the widening of bits formed during recording.

The groove depth of the pregrooves ranges from 5 to 150 nm. Pregrooves that are equal to or greater 5 nm in depth can permit an adequate degree of recording modulation, and a depth of equal to or less than 150 nm can permit the achieving of high reflectance. The upper limit of the pregroove depth is preferably equal to or lower than 100 nm, more preferably equal to or lower than 70 nm, and still more preferably, equal to or lower than 50 nm. The lower limit is preferably equal to or higher than 10 nm, more preferably equal to or higher than 20 nm, and still more preferably, equal to or higher than 28 nm.

As set forth above, when the recording layer is formed on the support over a reflective layer, the use of a thick reflective layer results in the pregrooves on the reflective layer being much narrower than those on the support. When that happens, even when pregrooves on the support are designed to yield desired characteristics, it may be difficult to achieve adequate characteristics. Thus, to achieve desired characteristics, it is preferable to employ a thin reflective layer. The thickness of the reflective layer will be described further below. When a reflective layer is present in the optical information recording medium of the present invention, it is preferable from the perspective of enhancing characteristics for the groove width of the pregrooves on the reflective layer to be 80 to 200 nm and the groove depth to range from 20 to 50 nm.

The upper limit of the groove tilt angle of the pregrooves is preferably equal to or less than 80°, more preferably equal to or less than 75°, further preferably equal to or less than 70°, and still more preferably, equal to or less than 65°. The lower limit is preferably equal to or greater than 20°, more preferably equal to or greater than 30°, and still more preferably, equal to or greater than 40°.

When the groove tilt angle of the pregrooves is equal to or greater than 20°, an adequate tracking error signal amplitude can be achieved, and at equal to or less than 80°, shaping properties are good.

### Recordable Layer

The recordable layer of Embodiment (1) can be formed by preparing a coating liquid by dissolving the phthalocyanine derivative denoted by general formula (I) and the compound denoted by general formula (II) in a suitable solvent with or without the use of a binder or the like, coating this coating liquid on the support or on a light reflective layer, described further below, to form a coating, and then drying the coating. The recordable layer may comprise a single layer or multiple layers. When the structure is multilayer, the step of coating the coating liquid may be conducted multiple times.

The concentration of dye in the coating liquid generally ranges from 0.01 to 15 weight percent, preferably ranges from 0.1 to 10 weight percent, more preferably ranges from 0.5 to 5 weight percent, and still more preferably, ranges from 0.5 to 3 weight percent

Examples of the solvent employed in preparing the coating liquid are: esters such as butyl acetate, ethyl lactate, and Cellosolve acetate; ketones such as methyl ethyl ketone, cyclohexanone, and methyl isobutyl ketone; chlorinated hydrocarbons such as dichloromethane, 1,2-dichloroethane, and chloroform; amides such as dimethylformamide; hydrocarbons such as methylcyclohexane; ethers such as tetrahydrofuran, ethyl ether, and dioxane; alcohols such as ethanol, n-propanol, isopropanol, and n-butanol diacetone alcohol; fluorine solvents such as 2,2,3,3-tetrafluoro-1-propanol; and glycol ethers such as ethylene glycol monomethylether, ethylene glycol monoethylether, and propylene glycol monomethylether.

The solvents may be employed singly or in combinations of two or more in consideration of the solubility of the dyes employed. Binders, oxidation inhibitors, UV absorbing agents, plasticizers, lubricants, and various other additives may be added to the coating liquid as needed.

Examples of coating methods are spraying, spincoating, dipping, roll coating, blade coating, doctor roll coating, and screen printing.

During coating, the temperature of the coating liquid preferably falls within a range of 20 to 50° C., more preferably within a range of 23 to 40° C., and further preferably, within a range of 24 to 30° C.

The thickness of the recordable layer on lands (protrusions on the support) is preferably equal to or less than 100 nm, more preferably equal to or less than 70 nm, further preferably equal to or less than 50 nm, and still more preferably, equal to or less than 30 nm. The lower limit is preferably equal to or greater than 1 nm, more preferably equal to or greater than 5 nm, further preferably equal to or greater than 10 nm, and still more preferably, equal to or greater than 15 nm.

The thickness of the recordable layer on grooves (indentation in the support) is preferably equal to or less than 150 nm, more preferably equal to or less than 100 nm, and further preferably, equal to or less than 50 nm. The lower limit is preferably equal to or greater than 5 nm, more preferably equal to or greater than 10 nm, and further preferably, equal to or greater than 20 nm.

The ratio of the thickness of the recordable layer on lands to the thickness of the recordable layer on grooves (thickness on lands/thickness on grooves) is preferably equal to or less than 1.0, more preferably equal to or less than 0.8, further preferably equal to or less than 0.7, and still more preferably, equal to or less than 0.6.

Examples of the binder when the coating liquid contains a binder are: natural organic polymeric substances such as gelatins, cellulose derivatives, dextran, rosin, and rubber; and synthetic organic polymers such as the initial condensation products of thermosetting resins such as hydrocarbon-based resins such as polyethylene, polypropylene, polystyrene, and polyisobutylene, vinyl-based resins such as polyvinyl chloride, polyvinylidene chloride, and polyvinyl chloride-polyvinyl acetate copolymers, acrylic resins such as polymethyl acrylate and polymethyl methacrylate, polyvinyl alcohols, chlorinated polyethylene, epoxy resin, butyral resin, rubber derivatives, and phenol- formaldehyde resin. When employing a binder as a material in the recordable layer, the quantity of binder employed generally ranges from 0.01 to 50-fold (by weight) and preferably ranges from 0.1 to 5-fold (by weight) the quantity of the dye.

A singlet oxygen quencher can be added to the recording layer formed with the phthalocyanine of general formula (I) in addition to the compound of general formula (II) to enhance light resistance. A known singlet oxygen quencher that has been described in publications such as patent specifications may be employed.

Specific examples are those described in Japanese Unexamined Patent Publication (KOKAI) Showa Nos. 58-175693, 59-81194, 60-18387, 60-19586, 60-19587, 60-35054, 60-63190, 60-36191, 60-44554, 60-44555, 60-44389, 60-44390, 60-54892, 60-47069, and 63-209995; Japanese Unexamined Patent Publication (KOKAI) Heisei No. 4-25492; Japanese Examined Patent Publication (KOKOKU) Heisei Nos. 1-38680 and 6-26028; German Patent 350,399; and the Bulletin of the Chemical Society of Japan, October, 1992, p. 1141, which are expressly incorporated herein by reference in their entirety.

The quantity of antifading agent in the form of the above singlet oxygen quencher or the like normally falls within a range of 0.1 to 50 weight percent, preferably falls within a range of 0.5 to 45 weight percent, more preferably falls within a range of 3 to 40 weight percent, and still more preferably, falls within a range of 5 to 25 weight percent, of the quantity of dye.

### Protective Layer (Cover Layer)

The cover layer in embodiment (1) is normally adhered through a bonding agent or adhesive onto the above-described recordable recording layer or onto a barrier layer such as that shown in FIG. 1.

The cover layer is not specifically limited, other than that it be a film of transparent material. An acrylic resin such as a polycarbonate or polymethyl methacrylate; a vinyl chloride resin such as polyvinyl chloride or a vinyl chloride copolymer; an epoxy resin; amorphous polyolefin; polyester; or cellulose triacetate is preferably employed. Of these, the use of polycarbonate or cellulose triacetate is more preferable.

The term “transparent” means having a transmittance of equal to or greater than 80 percent for the beam used in recording and reproducing.

The cover layer may further contain various additives so long as they do not compromise the effect of the present invention. For example, UV-absorbing agents may be incorporated to cut light with the wavelength of equal to or shorter than 400 nm and/or dyes may be incorporated to cut light with the wavelength of equal to or longer than 500 nm.

As for the physical surface properties of the cover layer, both the two-dimensional roughness parameter and three-dimensional roughness parameter are preferably equal to or less than 5 nm.

From the perspective of the degree of convergence of the beam employed in recording and reproducing, the birefringence of the cover layer is preferably equal to or lower 10 nm.

The thickness of the cover layer can be suitably determined based on the NA or wavelength of the laser beam irradiated in recording and reproducing. In the present invention, the thickness preferably falls within a range of 0.01 to 0.5 mm, more preferably a range of 0.05 to 0.12 mm.

The total thickness of the cover layer and bonding or adhesive layer is preferably 0.09 to 0.11 mm, more preferably 0.095 to 0.105 mm.

A protective layer (hard coating layer 44 in the embodiment shown in FIG. 1) may be provided on the incident light surface of the cover layer during manufacturing of the optical information recording medium to prevent scratching of the incident light surface.

To bond the cover layer and the recordable layer or barrier layer, a bonding layer or an adhesive layer may be provided between the two layers.

A UV-curable resin, EB-curable resin, thermosetting resin, or the like is preferably employed as the bond in the bonding layer, with the use of a UV-curable resin being preferred.

When employing a UV-curable resin as the bond, the UV-curable resin may be employed as is, or dissolved in a suitable solvent such as methyl ethyl ketone or ethyl acetate to prepare a coating liquid, which is then coated on the surface of the barrier layer with a dispenser. To prevent warping of the optical information recording medium that has been manufactured, a UV-curable resin having a low curing shrinkage rate is preferably employed in the bonding layer. Examples of such UV-curable resins are SD-640 and the like, made by Dainippon Ink and Chemicals, Inc.

The method of forming the bonding layer is not specifically limited. It is desirable to coat a prescribed quantity of bond on the surface of the barrier layer or the recordable layer (the bonded surface), dispose a cover layer thereover, uniformly spread the bond between the bonded surface and the cover layer by spin-coating or the like, and then cure the bond.

The thickness of the bonding layer preferably falls within a range of 0.1 to 100 micrometers, more preferably a range of 0.5 to 50 micrometers, and further preferably, 1 to 30 micrometers.

Examples of the adhesive employed in the adhesive layer are acrylic, rubber, and silicone adhesives. From the perspectives of transparency and durability, acrylic adhesives are preferable. Preferable acrylic adhesive is an acrylic adhesive comprising a main component in the form of 2-ethylhexyl acrylate, n-butyl acrylate, or the like copolymerized with a short-chain alkyl acrylate or methacrylate, such as methyl acrylate, ethyl acrylate, or methyl methacrylate to increase the cohesive force, and the component capable of becoming a crosslinking point with a crosslinking agent, such as acrylic acid, methacrylic acid, an acrylamide derivative, maleic acid, hydroxylethyl acrylate, or glycidyl acrylate. The type and blending ratio of the main component, short-chain component, and component for the addition of a crosslinking point can be suitably adjusted to vary the glass transition temperature (Tg) and crosslinking density.

When the recording layer containing the above-described phthalocyanine derivative is irradiated with a laser beam, the phthalocyanine derivative absorbs the laser beam and heats up. This heat thermally degrades the dye skeleton or its substituents, generating a gas. The gas is thought to form voids within pits. In the recording layer containing the above-described phthalocyanine derivative, the refractive index of the portion irradiated by the laser beam is generally about 1.6 to 1.9, while the refractive index of portions in which voids have been formed by irradiation by laser beam is about 1.0, varying greatly from that of unirradiated portions. This makes it possible to achieve a large refractive index differential, which is thought to permit good recording characteristics.

When forming voids in the recording layer by irradiation with a laser beam as set forth above, the formation of voids is normally accompanied by deformation of the recording layer. When deformation of the recording layer is impeded, the voids do not form well and it becomes difficult to obtain adequate recording characteristics. Generally, the support and reflective layer are more rigid than the adhesive layer and barrier layer. Thus, when voids form, the recording layer pushes the barrier layer up. When the adhesive layer positioned between the barrier layer and the cover layer is suitably flexible, deformation is produced in the adhesive layer in the form of depressions. When the adhesive layer positioned between the barrier layer and cover layer deforms readily, the formation of voids in the recording layer is not impeded, and pits can be properly formed. Thus, it is preferable for the adhesive layer to be suitably flexible so as to properly form pits. From this perspective, the glass transition temperature of the adhesive layer is preferably equal to or lower than 0° C., more preferably equal to or lower than −15° C., and further preferably, equal to or lower than −30° C. The lower limit is preferably equal to or higher than −60° C., more preferably equal to or higher than −50° C., and further preferably, equal to or higher than −45° C. At equal to or lower than 0° C., recording pits can be properly formed during recording. At equal to or higher than −60° C., adequately tight adhesion can be achieved at room temperature and durability can be ensured.

The glass transition temperature (Tg) can be measured by differential scanning calorimetry (DSC) with a DSC6200R made by Seiko Instruments, Inc.

The method described in Japanese Unexamined Patent Publication (KOKAI) No. 2003-217177, Japanese Unexamined Patent Publication (KOKAI) No. 2003-203387, Japanese Unexamined Patent Publication (KOKAI) Heisei No. 9-147418, which are expressly incorporated herein by reference in their entirety, or the like can be used to prepare the adhesive.

The method of forming the adhesive layer is not specifically limited. A prescribed quantity of adhesive can be uniformly coated on the surface of the barrier layer or recordable layer (the adhered surface), a cover layer can be disposed thereover, and the adhesive can be cured. Alternatively, a prescribed quantity of adhesive can be uniformly coated on one side of the cover layer to form a coating of adhesive, this coating can be adhered to the adhered surface, and then the adhesive can be cured.

Further, a commercial adhesive film on which an adhesive layer has been disposed in advance can be employed as the cover layer.

The thickness of the adhesive layer preferably falls within a range of 0.1 to 100 micrometers, more preferably a range of 0.5 to 50 micrometers, and further preferably, a range of 10 to 30 micrometers.

The cover layer can also be formed by spin-coating UV-curable resin.

### Other Layers

The optical information recording medium of embodiment (1) may optionally comprise other layers in addition to the above-described essential layers so long as the effect of the present invention is not compromised. Examples of such optional layers are a label layer having a desired image that is formed on the back of the support (the reverse unformed side from the side on which the recordable recording layer is formed), a light reflective layer positioned between the support and the recordable recording layer (described in detail further below), a barrier layer positioned between the recordable recording layer and the cover layer (described in detail further below), and a boundary layer positioned between the above light reflective layer and the recordable recording layer. The “label layer” may be formed from UV-curing resin, thermosetting resin, or heat-drying resin.

Each of the above-described essential layers and optional layers may have a single-layer or multilayer structure.

To increase reflectance for the laser beam and impart functions that enhance recording and reproducing characteristics to the optical information recording medium of embodiment (1), a light reflective layer is preferably formed between the support and the recordable recording layer.

The reflective layer can be formed, for example, by vacuum vapor depositing, by sputtering, or by ion plating a light reflective substance with high reflectance for the laser beam on the support The thickness of the light reflective layer can range from 5 to 100 nm, preferably ranges from 10 to 80 nm, and more preferably ranges from 30 to 60 nm. As set forth above, with the optical information recording medium of the present invention, it is possible to achieve both recording sensitivity and light resistance in a BD-configured optical information recording medium having a thin light reflective layer.

The reflectance is preferably equal to or greater than 70 percent

Examples of light reflective substances of high reflectance are: metals and semimetals such as Mg, Se, Y, Ti, Zr, Hf, V, Nb, Ta, Cr, Mo, W, Mn, Re, Fe, Co, Ni, Ru, Rh, Pd, Ir, Pt, Cu, Ag, Au, Zn, Cd, Al, Ga, In, Si, Ge, Te, Pb, Po, Sn, Bi, Nd, and and stainless steel. These reflective substances may be employed singly, in combinations of two or more, or as alloys. Of these, alloys comprising Ag, that has high reflectance, together with two or more from among Cu, Nd, Bi, Pd, and Ni are preferable.

### Barrier Layer (Intermediate Layer)

In the optical information recording medium of Embodiment (1), as shown in FIG. 1, it is preferable to form a barrier layer between the recordable layer and the cover layer.

The barrier layer can be provided to enhance the storage properties of the recordable layer, enhance adhesion between the recordable layer and cover layer, adjust reflectance, adjust thermal conductivity, and the like.

The material employed in the barrier layer is one that passes the beam employed in recording and reproducing; it is not specifically limited beyond being able to perform this function. For example, it is generally desirable to employ a material with low permeability to gas and moisture that is also a dielectric.

Specifically, materials in the form of nitrides, oxides, carbides, and sulfides of Zn, Si, Nb, Ti, Te, Sn, Mo, Ge, and the like are preferable. ZnS, Nb₂Ox (4.8≦x≦5.0), MoO₂, GeO₂, TeO, SiO₂, TiO₂, ZnO, ZnS—SiO₂, SnO₂, ZnO—Ga₂O₃ are preferable, and Nb₂Ox, SnO₂, and ZnO—Ga₂O₃ are more preferable.

The barrier layer can be formed by vacuum film-forming methods such as vacuum vapor deposition, DC sputtering, RF sputtering, and ion plating. Of these, sputtering is preferred, and DC sputtering is of even greater preference.

The thickness of the barrier layer preferably falls within a range of 1 to 100 nm, more preferably within a range of 2 to 50 nm, and further preferably, within a range of 3 to 10 nm.

### Method of Recording and Reproducing Information

The present invention relates to a method of recording and reproducing information by irradiation of a laser beam having a wavelength of equal to or shorter than 450 nm onto the optical information recording medium of the present invention.

The method of recording and reproducing information of the present invention will be described below by means of the example of recording and reproducing information on the above-described preferred optical information recording medium of Embodiment (1).

First, while rotating the optical information recording medium at a constant linear speed (such as 0.5 to 10 m/s) or constant angular speed, a recording beam such as a semiconductor laser beam is irradiated from the cover layer side. Irradiation with this beam changes the optical characteristics of the portions that are irradiated, thereby recording information. In the embodiment shown in FIG. 1, recording laser beam 46 such as a semiconductor laser beam is irradiated from cover layer 16 side via first object lens 42 (having a numerical aperture NA of 0.85, for example). Irradiation by laser beam 46 causes recording layer 14 to absorb laser beam 46, raising the temperature locally and causing physical or chemical change (forming a pit, for example) that is thought to produce a change in optical characteristics, thereby recording information.

In the method of recording and reproducing information of the present invention, the recording and reproduction of information are conducted by irradiation of a laser beam with a wavelength of equal to or shorter than 450 nm. A semiconductor laser having an oscillation wavelength of equal to or shorter than 450 nm, preferably falling within a range of 390 to 450 nm, is suitably employed as the recording beam. A blue-violet semiconductor laser beam having an oscillation wavelength falling within a range of 390 to 415 nm and a blue-violet SHG laser beam having a core oscillation wavelength of 425 nm obtained by halving the wavelength of an infrared semiconductor laser beam having a core oscillation wavelength of 850 nm with an optical waveguide element are examples of preferable light sources. In particular, a blue-violet semiconductor laser beam having an oscillation wavelength falling within a range of 390 to 415 nm is preferably employed from the perspective of recording density. The information that is thus recorded can be reproduced by directing the semiconductor laser beam from the cover layer side while rotating the optical information recording medium at the same constant linear speed as above and detecting the reflected beam.

### EXAMPLES

The present invention will be described in detail below based on examples. However, the present invention is not limited to the examples.

### Examples 1 to 10

### Preparation of Optical Information Recording Medium

(Preparation of Support)

An injection molded support comprised of polycarbonate resin and having a thickness of 1.1 mm, an outer diameter of 120 mm, an inner diameter of 15 mm, and spiral pregrooves (with a pitch of 320 nm, a groove depth of 40 nm, and a width of 160 nm) was prepared. Mastering of the stamper employed during injection-molding was conducted by electronic beam cutting device.

(Formation of Light Reflective Layer)

An ANC (Ag, Nd, Cu alloy) light reflective layer 50 nm in thickness was formed on the support as a vacuum-formed film layer by DC sputtering in an Ar atmosphere using a Cube manufactured by Unaxis Corp. The thickness of the light reflective film was adjusted by means of the duration of sputtering.

(Formation of a Recording Layer)

A 1.2 g quantity of each of the compound combinations of (S-1) to (S-10) shown in Table 3 was separately added to and dissolved in 100 mL of 2,2,3,3-tetrafluoropropanol and each of dye-containing coating liquids was prepared. The dye-containing coating liquids that had been prepared were then coated on light reflective layers by spincoating while varying the rotational speed from 300 to 4,000 rpm under conditions of 23° C. and 50 percent RH. They were subsequently maintained for one hour at 23° C. and 50 percent RH to form recordable layers (50 nm thickness on grooves, 20 nm thickness on lands).

After forming the recordable layer, annealing was conducted in a clean oven. In the annealing process, the supports were supported while creating a gap with spacers in the vertical stack pole and maintained for 1 hour at 80° C.

(Formation of a Barrier Layer)

Subsequently, a Cube made by Unaxis Corp. was employed to form by DC sputtering in an O₂ and argon atmosphere a barrier layer comprised of NbOx 5 nm in thickness on the recordable layer.

(Adhesion of a Cover Layer)

A cover layer in the form of a polycarbonate film (Teijin Pureace, 80 micrometers in thickness) measuring 15 mm in inner diameter, 120 mm in outer diameter, and having an adhesive layer on one side was provided so that the combined thickness of the adhesive layer (Tg: −45° C.) and the polycarbonate film was 100 micrometers.

After placing the cover layer on the barrier layer with the adhesive layer in contact with the barrier layer, a member was placed against the cover layer and pressure was applied in a vacuum chamber (equal to or lower than 50 Pa), bonding the cover layer and barrier layer. The optical information recording media of Examples 1 to 10 were prepared by the above process.

### Example 11

With the exception that the thickness of the reflective layer was changed to 10 nm, an optical information recording medium was prepared by the same method as in Example 1.

### Example 12

With the exception that the thickness of the reflective layer was changed to 30 nm, an optical information recording medium was prepared by the same method as in Example 1.

### Example 13

With the exception that the thickness of the reflective layer was changed to 60 nm, an optical information recording medium was prepared by the same method as in Example 1.

### Example 14

With the exceptions that the groove depth of the molded support was changed to 40 nm and the groove width to 140 nm, an optical information recording medium was prepared by the same method as in Example 1.

### Example 15

With the exceptions that the groove depth of the molded support was changed to 40 nm and the groove width to 180 nm, an optical information recording medium was prepared by the same method as in Example 1.

### Example 16

With the exceptions that the thickness of the reflective layer was changed to 30, the groove depth of the molded support to 40 nm, and the groove width to 140 nm, an optical information recording medium was prepared by the same method as in Example 1.

### Example 17

With the exception that an adhesive with a Tg of −35° C. was employed, an optical information recording medium was prepared by the same method as in Example 1.

### Example 18

With the exception that an adhesive with a Tg of −15° C. was employed, an optical information recording medium was prepared by the same method as in Example 1.

### Comparative Examples 1 to 4

With the exception that compound combination (S-1) was replaced with comparative combinations (H-1) to (H-4) shown in Table 3, optical information recording media were prepared by the same method as in Example 1.

TABLE 3

| | (i) Phthalocyanine | (ii) Compound | Amount of (ii) |
|---|---|---|---|
| | derivative denoted | denoted by | added per 100 |
| | by general formula | general formula | weight parts of (i) |
| Combination | (I) | (II) | (weight part) |
| (S-1) | (I-1) | (II-1) | 5 |
| (S-2) | (I-1) | (II-2) | 5 |
| (S-3) | (I-1) | (II-2) | 10 |
| (S-4) | (I-1) | (II-6) | 5 |
| (S-5) | (I-1) | (II-6) | 10 |
| (S-6) | (I-7) | (II-2) | 3 |
| (S-7) | (I-7) | (II-7) | 3 |
| (S-8) | (I-11) | (II-1) | 5 |
| (S-9) | (I-11) | (II-6) | 10 |
| (S-10) | (I-15) | (II-2) | 10 |
| (H-1) | (I-1) | None | — |
| (H-2) | (I-11) | None | — |
| (H-3) | (I-1) | Comparative | 5 |
| | | compound (A) | |
| (H-4) | (I-1) | Comparative | 10 |
| | | compound (B) | |

Comparative compound (A): Example compound (II-3) described in Japanese Unexamined Patent Publication (KOKAI) No. 2007-7954

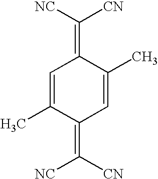

Comparative compound (B): Example compound (II-4) described in Japanese Unexamined Patent Publication (KOKAI) No. 2007-7954

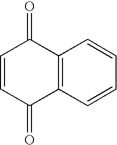

### Evaluation of the Optical Information Recording Media

A blue-violet semiconductor laser beam with an oscillation wavelength of 405 nm was used to record a 2T signal in a 17 PP modulation system on the optical information recording media that were prepared, after which the recorded signals were reproduced. The laser output at which the C/N ratio reached 45 dB and the maximum C/N ratio reached were measured. The optical disks were irradiated with a 170,000 Lx xenon lamp for 55 hours. A recording and reproduction test was then conducted in the same manner as above to measure the laser output at which the C/N ratio reached 45 dB. In this process, evaluation was conducted for the case where the xenon light was irradiated from the cover layer side of the optical information recording medium and the case where the xenon light was irradiated from the support side of the optical information recording medium. In the case where the xenon light was irradiated from the cover layer side of the optical information recording medium, the xenon light passed through the cover layer, barrier layer, and adhesive layer on its way to the recording layer, whereas in the case where the xenon light was irradiated from the support side of the optical information recording medium, the recording layer was irradiated through the support and reflective layer. Recording and recording characteristic evaluation were conducted with a DDU1000 made by Pulsetec. The evaluation results are given in Table 4. A large maximum C/N ratio attained indicated good recording properties. When the maximum C/N ratio reached was equal to or higher than 47 dB, the recording properties were deemed good. A laser output at which a C/N ratio of 45 dB was reached of equal to or lower than 5 mW indicated that the necessary high sensitivity in essence had been reached. When a laser output at which a C/N ratio of 45 dB was reached of equal to or lower than 5 mW was maintained after irradiation, it was possible to determine that storage stability was adequately high.

TABLE 4

| | | | Groove | | | | | |
|---|---|---|---|---|---|---|---|---|
| | | | depth (nm)/ | | | | | |
| | | | groove | | | | | |
| | | | width (nm) of | | | | | |
| | | | molded suppor | | | | | |
| | | | Groove | | | Recording power (C/N 45 dB, mW) | | |
| | Combination of | Thickness of | depth (nm)/groove | Tg of adhesive | | | After irradiation | |
| | compounds in | reflective | width (nm) on | layer | Maximum C/N | | from cover layer | After irradiation from |
| | recording layer | layer (nm) | reflective layer | (° C.) | reached | Fresh | side | support side |
| Ex. 1 | S-1 | 50 | 40/160 | −45 | 51 dB | 4.6 | 4.6 | 4.6 |
| | | | 41/140 | | | | | |
| Ex. 2 | S-2 | 50 | 40/160 | −45 | 50 dB | 4.6 | 4.6 | 4.6 |
| | | | 41/140 | | | | | |
| Ex. 3 | S-3 | 50 | 40/160 | −45 | 51 dB | 4.2 | 4.3 | 4.2 |
| | | | 41/140 | | | | | |
| Ex. 4 | S-4 | 50 | 40/160 | −45 | 50 dB | 4.9 | 4.9 | 4.9 |
| | | | 41/140 | | | | | |
| Ex. 5 | S-5 | 50 | 40/160 | −45 | 51 dB | 4.5 | 4.6 | 4.5 |
| | | | 41/140 | | | | | |
| Ex. 6 | S-6 | 50 | 40/160 | −45 | 50 dB | 3.9 | 4.3 | 4.1 |
| | | | 41/140 | | | | | |
| Ex. 7 | S-7 | 50 | 40/160 | −45 | 52 dB | 4 | 4.4 | 4.3 |
| | | | 41/140 | | | | | |
| Ex. 8 | S-8 | 50 | 40/160 | −45 | 51 dB | 4.8 | 4.9 | 4.9 |
| | | | 41/140 | | | | | |
| Ex. 9 | S-9 | 50 | 40/160 | −45 | 50 dB | 4.6 | 4.8 | 4.7 |
| | | | 41/140 | | | | | |
| Ex. 10 | S-10 | 50 | 40/160 | −45 | 51 dB | 4.8 | 4.9 | 4.9 |
| | | | 41/140 | | | | | |
| Ex. 11 | S-1 | 10 | 40/160 | −45 | 56 dB | 4.9 | 4.9 | 5.0 |
| | | | 40/155 | | | | | |
| Ex. 12 | S-1 | 30 | 40/160 | −45 | 55 dB | 4.7 | 4.7 | 4.8 |
| | | | 41/150 | | | | | |
| Ex. 13 | S-1 | 60 | 40/160 | −45 | 50 dB | 4.3 | 4.5 | 4.3 |
| | | | 41/135 | | | | | |
| Ex. 14 | S-1 | 50 | 40/140 | −45 | 48 dB | 4.6 | 4.6 | 4.6 |
| | | | 41/125 | | | | | |
| Ex. 15 | S-1 | 50 | 40/180 | −45 | 56 dB | 4.5 | 4.6 | 4.6 |
| | | | 41/160 | | | | | |
| Ex. 16 | S-1 | 30 | 40/140 | −45 | 50 dB | 4.7 | 4.8 | 4.8 |
| | | | 41/130 | | | | | |
| Ex. 17 | S-1 | 50 | 40/160 | −35 | 48 dB | 4.8 | 4.8 | 4.8 |
| | | | 41/140 | | | | | |
| Ex. 18 | S-1 | 50 | 40/160 | −15 | 48 dB | 5.0 | 5.0 | 5.0 |
| | | | 41/140 | | | | | |
| Comp. Ex. 1 | H-1 | 50 | 40/160 | −45 | 49 dB | 5.7 | 5.7 | 5.7 |
| | | | 41/140 | | | | | |
| Comp. Ex. 2 | H-2 | 50 | 40/160 | −45 | 49 dB | 6.2 | 6.4 | 6.3 |
| | | | 41/140 | | | | | |
| Comp. Ex. 3 | H-3 | 50 | 40/160 | −45 | 50 dB | 4.8 | 5.7 | 5.2 |
| | | | 41/140 | | | | | |
| Comp. Ex. 4 | H-4 | 50 | 40/160 | −45 | 48 dB | 5.3 | 5.8 | 5.6 |
| | | | 41/140 | | | | | |

The results shown in Table 4 indicate that the optical disks (Examples 1 to 18) having a recording layer containing the phthalocyanine derivative denoted by general formula (I) and the compound (II) denoted by general formula (II) had much greater sensitivity to the blue-violet semiconductor laser beam than when no compound denoted by general formula (II) was contained (Comparative Examples 1 and 2), and exhibited a much lower drop in sensitivity in the light discoloration test than when either comparative compound (A) or (B) was contained (Comparative Examples 3 and 4). In particular, optical disks having a recording layer containing the phthalocyanine derivative denoted by general formula (I) and the compound (II) denoted by general formula (II) exhibited high sensitivity and good storage stability in the form of a laser output at which a C/N ratio of 45 dB was reached of equal to or less than 5 mW following irradiation with light from the support side, even when the reflective layer was relatively thin (Examples 11, 12, and 16). A comparison of Example 1 and Examples 11 and 12 reveals that a reduction in the thickness of the reflective layer made pregrooves on the reflective layer close to the pregrooves on the support in shape, thereby enhancing recording properties.

From the results described above, it can be understood that use of the phthalocyanine derivative denoted by general formula (I) and the compound (II) denoted by general formula (II) yielded optical disks affording both high recording sensitivity to short-wavelength laser beams and good storage stability.

The optical information recording medium of the present invention is suitable as an optical information recording medium for high-density recording such as Blu-ray optical disks.

Although the present invention has been described in considerable detail with regard to certain versions thereof, other versions are possible, and alterations, permutations and equivalents of the version shown will become apparent to those skilled in the art upon a reading of the specification and study of the drawings. Also, the various features of the versions herein can be combined in various ways to provide additional versions of the present invention. Furthermore, certain terminology has been used for the purposes of descriptive clarity, and not to limit the present invention. Therefore, any appended claims should not be limited to the description of the preferred versions contained herein and should include all such alterations, permutations, and equivalents as fall within the true spirit and scope of the present invention.

Having now fully described this invention, it will be understood to those of ordinary skill in the art that the methods of the present invention can be carried out with a wide and equivalent range of conditions, formulations, and other parameters without departing from the scope of the invention or any embodiments thereof.

All patents and publications cited herein are hereby fully incorporated by reference in their entirety. The citation of any publication is for its disclosure prior to the filing date and should not be construed as an admission that such publication is prior art or that the present invention is not entitled to antedate such publication by virtue of prior invention.

Unless otherwise stated, a reference to a compound or component includes the compound or component by itself, as well as in combination with other compounds or components, such as mixtures of compounds.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention. At the very least, and not to be considered as an attempt to limit the application of the doctrine of equivalents to the scope of the claims, each numerical parameter should be construed in light of the number of significant digits and ordinary rounding conventions.

Additionally, the recitation of numerical ranges within this specification is considered to be a disclosure of all numerical values and ranges within that range. For example, if a range is from about 1 to about 50, it is deemed to include, for example, 1, 7, 34, 46.1, 23.7, or any other value or range within the range.

What is claimed is:

1. An optical information recording medium comprising a recording layer on a surface of a support, wherein
the surface of the support has pregrooves with a track pitch ranging from 50 to 500 nm, and
the recording layer comprises a phthalocyanine derivative denoted by general formula (I) and a compound denoted by general formula (II). 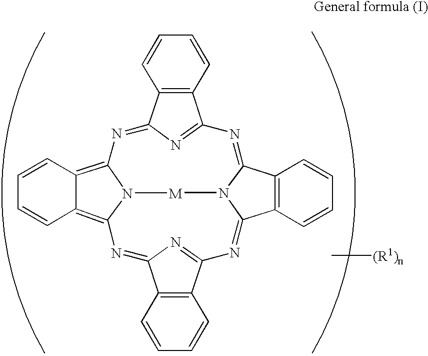
In general formula (I), R¹ denotes a substituent, n denotes an integer ranging from 1 to 16, plural ns may be identical or different from each other when n is an integer of equal to or greater than 2, and M denotes a metal atom optionally comprising a ligand, a metal oxide, or two hydrogen atoms. 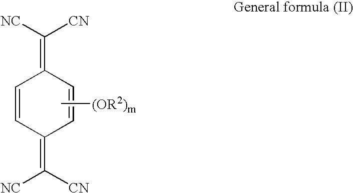
In general formula (II), R² denotes a substituted or unsubstituted alkyl group having 1 to 18 carbon atoms or a substituted or unsubstituted aryl group having 4 to 24 carbon atoms, m is an integer ranging from 1 to 4, and plural R²s may be identical or different from each other when m denotes an integer of equal to or greater than 2.

2. The optical information recording medium according to claim 1, further comprising a light reflective layer between the support and the recording layer.

3. The optical information recording medium according to claim 2, wherein the light reflective layer has a thickness ranging from 5 to 100 nm.

4. The optical information recording medium according to claim 1, further comprising a barrier layer, a bonding layer or adhesive layer, and a protective layer in this order on a surface of the recording layer, the surface being opposite from the surface facing the support.

5. The optical information recording medium according to claim 1, wherein information is recorded by irradiation of a laser beam having a wavelength of equal to or shorter than 450 nm.

6. The optical information recording medium according to claim 1, wherein the recording layer comprises the compound denoted by general formula (II) in an amount of 1 to 20 weight parts per 100 weight parts of the phthalocyanine derivative denoted by general formula (I).

7. The optical information recording medium according to claim 1, wherein R¹ in general formula (I) denotes a substituent selected from the group consisting of an substituted or unsubstituted alkylsulfonyl group having 1 to 21 carbon atoms, substituted or unsubstituted arylsulfonyl group having 4 to 24 carbon atoms, substituted or unsubstituted alkylsulfinyl group having 1 to 21 carbon atoms, substituted or unsubstituted arylsulfinyl group having 4 to 24 carbon atoms, substituted or unsubstituted alkylsulfamoyl group having 1 to 21 carbon atoms, and substituted or unsubstituted arylsulfamoyl group having 4 to 24 carbon atoms.

8. The optical information recording medium according to claim 1, wherein M in general formula (I) denotes a copper atom, magnesium atom, zinc atom, or silicon atom.

9. A method of recording and reproducing information by irradiation of a laser beam having a wavelength of equal to or shorter than 450 nm onto the optical information recording medium according to claim 1.
